(19) United States
(12) Patent Application Publication
(10) Pub. No.: US 2025/0212970 A1
(43) Pub. Date: Jul. 3, 2025

(54) CLEANING TOOL FOR CLEANING AN AEROSOL PROVISION DEVICE

(71) Applicant: NICOVENTURES TRADING LIMITED, London (GB)

(72) Inventor: Jonathon BURGESS, London (GB)

(21) Appl. No.: 18/850,297

(22) PCT Filed: Mar. 23, 2023
(86) PCT No.: PCT/EP2023/057516

§ 371 Date: Sep. 24, 2024

(30) Foreign Application Priority Data
Mar. 25, 2022 (GB) 2204265.9

(51) Int. Cl. A24F 40/85; A46B 3/18; A46B 15/00; A46D 1/00

(52) U.S. Cl. CPC A24F 40/85; A46B 3/18; A46B 15/0095; A46D 1/0207

(57) ABSTRACT

A cleaning tool for cleaning an aerosol provision device including a first part having a handle portion having a support depending or extending therefrom and a plurality of bristles or pads depending or extending from a distal end of the support. The cleaning tool further includes a second part having a housing for receiving the first part, wherein the housing further includes an engagement mechanism for engaging with a cover of an aerosol provision device in order to remove or displace the cover.

### RELATED APPLICATIONS

The present application is a National Phase entry of PCT Application No. PCT/EP2023/057516 filed Mar. 23, 2023, which claims priority to GB Application No. 2204265.9 filed Mar. 25, 2022, each of which is hereby incorporated by reference in their entirety.

### TECHNICAL FIELD

The present invention relates to a cleaning tool for cleaning an aerosol provision device, a method of cleaning an aerosol provision device and an aerosol provision system.

### BACKGROUND

Smoking articles such as cigarettes, cigars and the like burn tobacco during use to create tobacco smoke. Attempts have been made to provide alternatives to these articles by creating products that release compounds without combusting. Examples of such products are so-called “heat not burn” products or tobacco heating devices or products, which release compounds by heating, but not burning, material. The material may be, for example, tobacco or other non-tobacco products, which may or may not contain nicotine.

Aerosol provision systems, which cover the aforementioned devices or products, are known. Common systems use heaters to create an aerosol from a suitable medium which is then inhaled by a user. Often the medium used needs to be replaced or changed to provide a different aerosol for inhalation.

A problem with known aerosol provision devices is that they can become dirty and may need to be cleaned.

### SUMMARY

According to an aspect there is provided a cleaning tool for cleaning an aerosol provision device comprising:

a first part comprising a handle portion having a support depending or extending therefrom and a plurality of bristles or pads depending or extending from a distal end of the support; and

a second part comprising a housing for receiving the first part, wherein the housing further comprises an engagement mechanism for engaging with a cover of an aerosol provision device in order to remove or displace the cover.

The cleaning tool according to various embodiments enables a user to open and remove or displace a cover which may be provided, for example, at the distal end of an aerosol provision device thereby exposing an opening which may lead into a heating chamber of the aerosol provision device. A different portion of the cleaning tool which includes a support with a plurality of bristles or pads depending or extending therefrom can then be used to clean inside the heating chamber of the aerosol provision device. The cleaning tool avoids a user attempting to clean the aerosol provision device using their finger and hence avoids a user inadvertently burning their finger.

Optionally, the support is formed from at least two strands of wire which are twisted together in order to secure the plurality of bristles or pads in position.

Optionally, the plurality of bristles or pads extend radially from the support.

Optionally, the support is straight, bent or curved.

Optionally, the handle portion of the first part comprises an external thread and the housing of the second part comprises a complimentary internal thread for securing the first and second parts together in a storage configuration.

It will be understood that whilst the first part and the second part may be fitted together for storage, the first part may be used separately from the second part for cleaning purposes.

Optionally, the housing of the second part houses at least a portion of the first part in a storage configuration.

Optionally, the engagement mechanism enables a cover of an aerosol provision device to be rotated or displaced.

Optionally, the engagement mechanism comprises a first protrusion for engaging with a first slot or cut-out provided in a cover of an aerosol provision device.

Optionally, the engagement mechanism further comprises a second protrusion having a different shape and/or dimension to the first protrusion, wherein the second protrusion is arranged to engage with a second slot or cut-out provided in the aerosol provision device, wherein the second slot or cut-out has a different shape and/or dimension to the first slot or cut-out.

Optionally, the handle portion of the first part further comprises a shoulder for resting in an aperture of an aerosol provision device when a cover has been removed or displaced by the engagement mechanism.

Optionally, the plurality of bristles comprise PEEK.

Optionally, the support comprises stainless steel.

Optionally, the cleaning tool further comprises a third part, the third part comprising a handle having a screw member dependent or extending therefrom for removing an aerosol generating article from an aerosol provision device.

Optionally, the screw member comprises stainless steel.

Optionally, the housing of the second part is further configured to receive the third part in a storage configuration.

Optionally, the housing of the second part houses at least a portion of the third part in a storage configuration.

It will be understood that whilst the third part and the second part may be fitted together for storage, the third part may be used separately from the second part for cleaning purposes.

According to another aspect there is provided a method of cleaning an aerosol provision device comprising:

engaging the engagement mechanism of the cleaning tool as described above with a cover of an aerosol provision device in order to remove or displace the cover;

inserting the plurality of bristles or pads of the first part of the cleaning tool into a receptacle of the aerosol provision device; and

translating the handle portion of the first part between first and second positions along a longitudinal axis of the aerosol provision device.

Optionally, the method further comprises moving the handle portion of the first part between the first and second positions a plurality of times.

Optionally, the method further comprises rotating the handle portion of the first part about the longitudinal axis of the aerosol provision device by at least a partial rotation.

According to another aspect there is provided an aerosol provision system comprising:

an aerosol provision device; and

a cleaning tool as described above.

Optionally, the aerosol provision device comprises a cover and wherein the engagement mechanism of the second part of the cleaning tool is arranged to engage the cover in use in order to remove or displace the cover.

### BRIEF DESCRIPTION OF THE DRAWINGS

Various embodiments will now be described, by way of example only, and with reference to the accompanying drawings in which:

FIG. 1 shows a front view of an aerosol provision device of a type which may be cleaned by a cleaning tool according to various embodiments;

FIG. 2 shows a perspective side view of the aerosol provision device shown in FIG. 1 and shows an outer cover at a distal end of the aerosol provision device, wherein an engagement mechanism provided on the cleaning tool is arranged to engage with the outer cover in order to remove or displace the cover;

FIG. 3 shows a schematic side view of an aerosol generator portion of the aerosol provision device shown in FIG. 1 and shows an opening provided in a distal end which provides access for a cleaning tool;

FIG. 4 shows a partial plan view of the base of the aerosol provision device shown in FIG. 1 and shows a tool slot for receiving an engagement mechanism of a cleaning tool in order to remove or displace a cover provided in the base of the aerosol provision device;

FIG. 5 shows a schematic side view of a cleaning tool for cleaning an aerosol provision device according to various embodiments, wherein the cleaning tool comprises: (i) a first part having a handle portion, a support and a plurality of bristles depending or extending from a distal end of the support; (ii) a second part having a housing for receiving the first part and wherein the housing comprises an engagement mechanism for engaging with a cover of an aerosol provision device in order to remove or displace the cover; and optionally (iii) a third part comprising a handle having a screw member dependent or extending therefrom for removing an aerosol generating article from an aerosol provision device; and

FIG. 6 shows a view of a distal end of the cleaning tool according to various embodiments and shows in greater detail an engagement mechanism provide on a distal end of the housing which is arranged to engage with a cover of an aerosol provision device in order to remove or displace the cover.

### DETAILED DESCRIPTION

As used herein, the term “aerosol-generating material” is a material that is capable of generating aerosol, for example when heated, irradiated or energized in any other way. Aerosol-generating material may, for example, be in the form of a solid, liquid or gel which may or may not contain an active substance and/or flavorants. Aerosol-generating material may include any plant based material, such as tobacco-containing material and may, for example, include one or more of tobacco, tobacco derivatives, expanded tobacco, reconstituted tobacco or tobacco substitutes. Aerosol-generating material also may include other, non-tobacco, products, which, depending on the product, may or may not contain nicotine. Aerosol-generating material may for example be in the form of a solid, a liquid, a gel, a wax or the like. Aerosol-generating material may for example also be a combination or a blend of materials. Aerosol-generating material may also be known as “smokable material”.

The aerosol-generating material may comprise a binder and an aerosol former. Optionally, an active and/or filler may also be present. Optionally, a solvent, such as water, is also present and one or more other components of the aerosol-generating material may or may not be soluble in the solvent. In some embodiments, the aerosol-generating material is substantially free from botanical material. In some embodiments, the aerosol-generating material is substantially tobacco free.

The aerosol-generating material may comprise an aerosol-generating film. The aerosol-generating film may comprise or be a sheet, which may optionally be shredded to form a shredded sheet. The aerosol-generating sheet or shredded sheet may be substantially tobacco free.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energised so as to distribute power in the form of heat to an aerosol-generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

An aerosol generating device can receive an article comprising aerosol generating material for heating. An “article” in this context is a component that includes or contains in use the aerosol generating material, which is heated to volatilize the aerosol generating material, and optionally other components in use. A user may insert the article into the aerosol generating device before it is heated to produce an aerosol, which the user subsequently inhales. The article may be, for example, of a predetermined or specific size that is configured to be placed within a heating chamber of the device which is sized to receive the article.

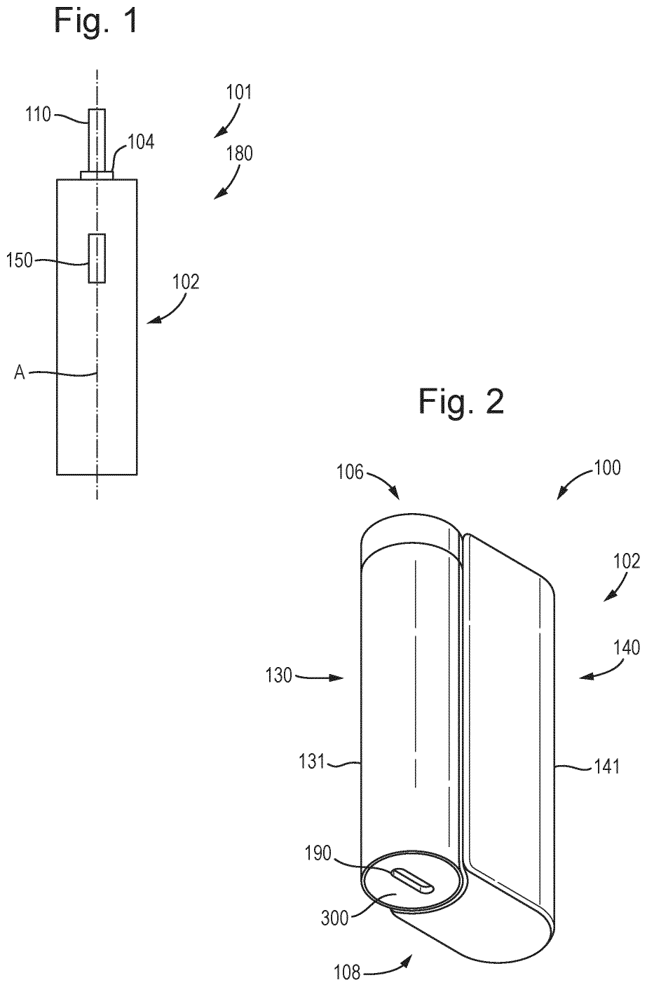

FIG. 1 shows for illustrative purposes an aerosol provision device 100 for generating aerosol from an article 110 comprising aerosol generating material which has been inserted into the aerosol provision device 100. The aerosol provision device 100 may be used to heat an article 110 comprising aerosol generating material in order to generate an aerosol or other inhalable medium which is inhaled by a user of the aerosol provision device 100. At the end of a session of use a spent article 110 may be removed from the aerosol provision device 100.

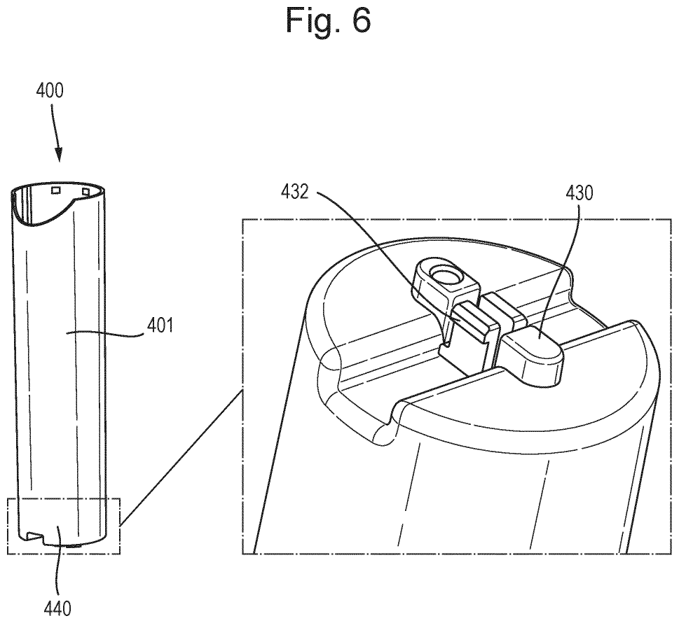

As will be discussed in more detail below, particularly with reference to FIGS. 5 and 6, according to various embodiments a cleaning tool for cleaning the aerosol provision device 100 is disclosed. The cleaning tool comprises a first part which includes bristles for cleaning an internal portion of the aerosol provision device 100 and a second part comprising a housing for receiving the first part. Furthermore, the housing includes an engagement mechanism for engaging with a cover of the aerosol provision device 100 in order to remove or displace the cover. As will be described in more detail below, the cover may be provided at a distal end of the aerosol provision device 100 and removal or displacement of the cover enables the first part of the cleaning tool to be inserted into the aerosol provision device 100 in order to clean a heating chamber located within the aerosol provision device.

The aerosol provision device 100 comprises a body 102. A housing arrangement surrounds and houses various components of the body 102. An article aperture 104 is formed at one end of the body 102 through which an article 110 may be inserted for heating by an aerosol generator (not shown) located within the aerosol provision device 100. The article 110 may be fully or partially inserted into the aerosol generator where the article 110 may be heated by one or more components of the aerosol generator. The article 110 and the aerosol provision device 100 together form an aerosol provision system 101.

The aerosol provision device 100 may also include a user-operable control element 150, such as a button or switch, which controls or operates components of the aerosol provision device 100 when pressed or otherwise activated. For example, a user may turn the aerosol provision device 100 ON by operating the control element 150. The aerosol generator defines a longitudinal axis A.

FIG. 2 shows a perspective view of the aerosol provision device 100. The aerosol provision device 100 may comprise a first body assembly 130 and a second body assembly 140. The first body assembly 130 may comprises an aerosol generator.

The first body assembly 130 comprises a first housing 131. The second body assembly 140 comprises a second housing 141. The first and second body assemblies 130,140 may be fixedly mounted. The first and second body assemblies 130,140 may together form the body 102.

The body 102 has end surfaces of the aerosol provision device 100. The end of the aerosol provision device 100 closest to the article aperture may be known as the proximal end (or mouth end) 106 of the aerosol provision device 100 because, in use, it is closest to the mouth of the user. In use, a user inserts an article into the aperture, operates the aerosol generator to begin heating the aerosol generating material and draws on the aerosol generated in the aerosol provision device 100. This causes the aerosol to flow through the aerosol provision device 100 along a flow path towards the proximal end 106 of the aerosol provision device 100.

The other end of the device furthest away from the aperture may be known as the distal end 108 of the aerosol provision device 100 because, in use, it is the end furthest away from the mouth of the user. As a user draws on the aerosol generated in the aerosol provision device 100, the aerosol flows in a direction towards the proximal end 106 of the aerosol provision device 100. The terms proximal and distal as applied to features of the aerosol provision device 100 will be described by reference to the relative positioning of such features with respect to each other in a proximal-distal direction along the longitudinal axis.

As used herein, a one-piece component refers to a component of a device which is not separable by a user into two or more components following assembly of the device. Integrally formed relates to two or more features that are formed into a one piece component during a manufacturing stage of the component.

An air flow passage extends through the body 102 and extends to an opening 190. The opening 190 acts as an air inlet. An outer cover 300 covers the opening 190. The outer cover 300 may be arranged to allow the flow of air into the air flow passage. The outer cover 300 may comprise a clean out door to aid with cleaning. The clean out door may be removable from the aerosol provision device 100 thereby providing access to a cleanout chamber within the aerosol provision device 100.

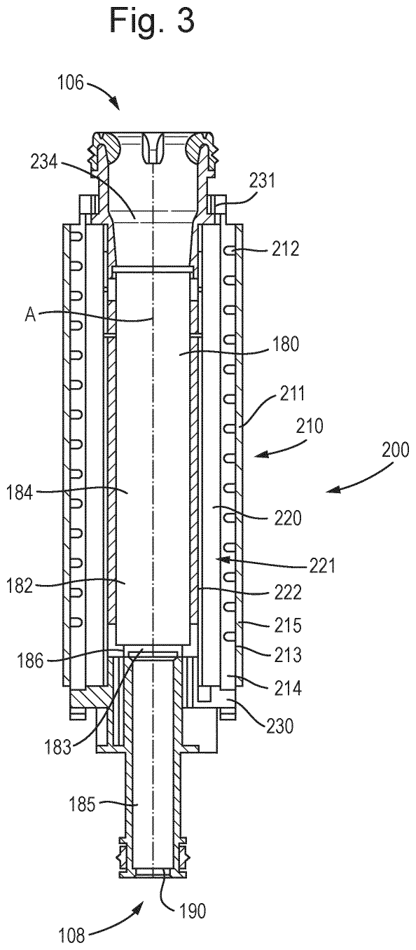

FIG. 3 shows a cross-sectional view of an aerosol generator 200 which forms part of the aerosol provision device. In one example, the aerosol generator 200 may comprise an induction-type heating system, including a magnetic field generator 210. The magnetic field generator 210 comprises an inductor coil assembly 211. The aerosol generator 200 also comprises a heating element or susceptor 220.

A susceptor is a material that is heatable by penetration with a varying magnetic field, such as an alternating magnetic field. The susceptor may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The susceptor may be both electrically-conductive and magnetic, so that the susceptor is heatable by both heating mechanisms. The device that is configured to generate the varying magnetic field is referred to as a magnetic field generator, herein.

The aerosol generator 200 may comprise an inductive heating assembly and may comprise various components to heat aerosol generating material provided on an article via an inductive heating process. Induction heating is a process of heating an electrically conducting object (such as a susceptor) by electromagnetic induction.

The inductor coil assembly 211 may comprise a first inductor coil 212 and a second inductor coil 213. Alternatively, a single inductor coil may be provided. The inductor coil assembly 211 may comprise a coil support 214 which may be tubular. The coil support 214 may comprise a guide 215 for the first inductor coil 212 and the second inductor coil 213. The guide 215 may comprise a channel on an outer side of the coil support 214.

The heating element or susceptor 220 may form part of a heating assembly 221. The heating element or susceptor 220 may be hollow and may define at least part of a receptacle 222 within which aerosol generating material may be received in use. For example, an article may be inserted into the aerosol generator 200 so as to be in close proximity to the heating element or susceptor 220. The heating element or susceptor 220 may be tubular and may have a circular cross section. The heating element or susceptor 220 may have a generally constant diameter along its axial length.

The heating element or susceptor 220 may be formed from an electrically conducting material suitable for heating by electromagnetic induction. For example, the heating element or susceptor 220 may comprise a carbon steel. It will be understood that other suitable materials may be used, for example a ferromagnetic material such as iron, nickel or cobalt.

Other arrangements are contemplated wherein a heating element may be provided which is heatable by electrical resistance. The aerosol generator 200 may therefore comprise electrical contacts for electrical connection with the apparatus for electrically activating the heating element by passing a flow of electrical energy through the heating element.

The receptacle 222 and an associated article may be dimensioned so that the article is received adjacent the heating element or susceptor 220. This helps ensure that the heating is most efficient. The article may comprise aerosol generating material. The aerosol generating material may be positioned within the receptacle 222. The article may comprise other components such as a filter, wrapping materials and/or a cooling structure.

A first end support 230 may be provided which supports the heating element or susceptor 220. The first end support 230 may support the heating element or susceptor 220 at a first, distal, end. A second end support 231 may be provided which supports the heating element or susceptor 220 at a second, proximal, end. The first and second end supports 230,231 may act as receptacle supports.

An air flow passage 180 is provided which extends within the heating element or susceptor 220. The air flow passage 180 may extend to a first, distal, end. The air flow passage 180 may protrude beyond the heating element or susceptor 220. The air flow passage 180 may extend from the heating element or susceptor 220 and may be defined by a flow path member 182.

The flow path member 182 extends between the heating element or susceptor 220 and an opening 190 at a distal end 108. The flow path member 182 may be tubular and the flow path member 182 may define a bore. The flow path member 182 may extend in an axial direction along its length.

The flow path member 182 and the heating element or susceptor 220 may intersect at a juncture 183. The flow path member 182 may comprise a first section 184 having a first diameter and a second section 185 having a second diameter. The diameter of the first section 184 may be greater than the diameter of the second section 185. An intermediate section 186 may extend between the first and second sections 184, 185. The intermediate section 186 may form a shoulder which may act as a stop to limit insertion of an article.

A fluid seal at the juncture 183 may be formed by a mechanical fabricated joint such as a weld. A fluid seal at the juncture 183 may be alternatively formed by a laser weld process. It will be understood that other methods may be used such as brazing and adhering. The flow path member 182 may be formed from a thermally conductive material. It is contemplated that the flow path member 182 may be formed from a carbon steel. The flow path member 182 may be formed from the same material as the heating element or susceptor 220. By such processes the heating element or susceptor 220 and the flow path member 182 may be fabricated as a one-piece component.

The heating element or susceptor 220 may be abutted to the flow path member 182 thereby providing for heat transfer by conduction. As such, it is possible to aid passive heating of the flow path member 182.

The second end support 231 may define an insertion chamber 234 at the proximal end 106. The insertion chamber 234 may be configured to receive an article therethrough.

The heating element or susceptor 220 may extend between the first and second end supports 230,231. A barrier member may extend between the first end support 231 and the second end support 232.

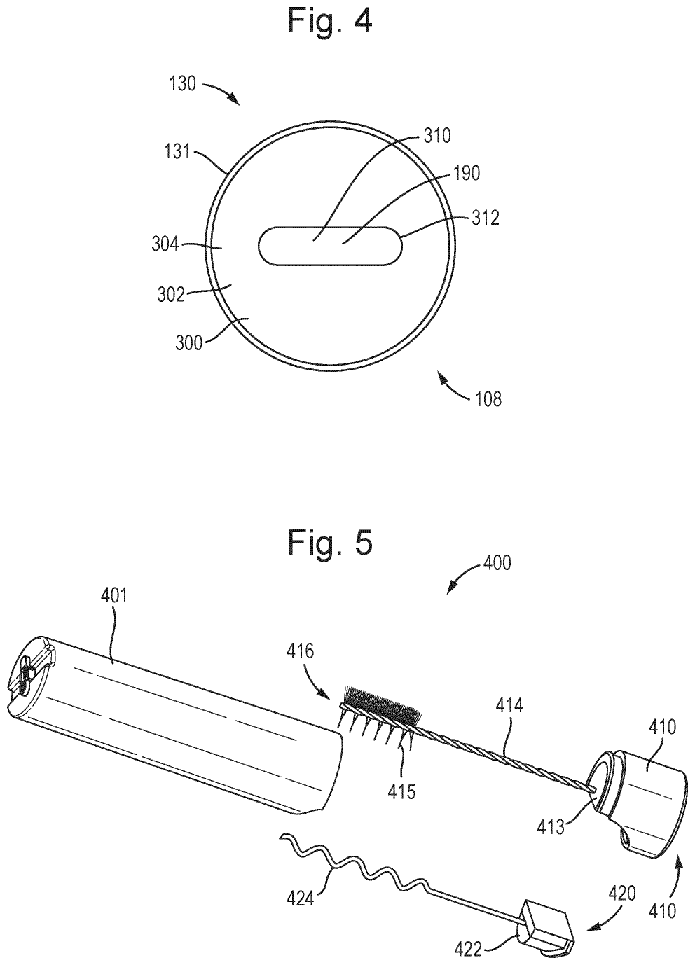

FIG. 4 shows a partial plan view of the base of an aerosol provision device according to an arrangement. The first body assembly 130 may be generally tubular. The first housing 131 may be tubular. The first housing 131 may have a circular cross-section. An outer cover 300 is disposed at the distal end 108 of the first housing 131. The outer cover 300 covers the opening 190 at the distal end 108 of the first housing 131. When disposed in the first housing 131, the outer cover 300 may be flush with the distal end 108 of the first housing 131. The outer cover 300 comprises a cover member 302. The cover member 302 has a first side 304 and a second side.

It will be understood that according to other arrangements the housing on which an outer cover is mounted may be non-tubular.

A cavity is provided at the distal end of the body and the cavity has an opening 190. The cavity is configured to receive a cover member 302. The cavity may have a depth generally corresponding to the thickness of the cover member 302.

The cover member 302 may be configured to be inserted into the opening 190. The cover member 302 and the cavity may have corresponding cross-sections. The cover member 302 may have a circular cross-sectional shape. An annular wall may be provided which connects the first side 304 of the cover member 302 to the second side. The annular wall may be configured to engage the first housing 131 either by an interference fit or by a threaded connection.

The first side 304 of the cover member 302 may comprise a tool receiving recess 310. The tool receiving recess 310 may be configured to receive a portion of a cleaning tool (not shown). In particular, the tool receiving recess 310 may be configured to receive an engagement mechanism of a cleaning tool. The cleaning tool will be described in more detail below with reference to FIGS. 5 and 6.

The cleaning tool may be configured so that an engagement mechanism of the cleaning tool is inserted in use into the tool receiving recess 310. The engagement mechanism may be arranged to remove or displace the outer cover 300 from the opening 190 thereby enabling access for a cleaning tool to be inserted into the opening 190. The tool receiving recess 310 may have a tool slot 312. The tool slot 312 may comprise an aperture configured to receive an engagement mechanism provided on the cleaning tool. The tool slot 312 may be elongate. The tool slot 312 and the engagement mechanism of the cleaning tool may have complimentary geometries.

The tool slot 312 may be disposed centrally on the first side 304 of the cover member 302. The tool slot 312 may be disposed centrally on the first side 304. However, other arrangements are contemplated wherein the geometry and location of the tool slot 312 may differ from the arrangement shown in FIG. 4. For example, the tool slot 312 may have a different shape and may be displaced from the center of the cover member 302.

FIG. 5 shows a schematic side view of a cleaning tool 400 for use with an aerosol provision device according to various embodiments. In particular, the cleaning tool 400 may be used to clean an aerosol provision device 100 of the type as described above with reference to FIGS. 1-4.

The cleaning tool 400 comprises a first part comprising a brush holder 410 which is insertable into a second part comprising a housing 401. The cleaning tool 400 may further comprise a third part 420 which comprises a screw 424 having a screw handle 422. The third part 420 may be used to remove an article or a portion of an article which has become stuck in the aerosol provision device.

The brush holder 410 may comprises a brush holder chassis 412 which can be inserted into the housing 401. The brush holder chassis 412 may be retained in the housing 401 by an interference fit. According to other arrangements the brush holder chassis 412 may be externally threaded and the housing 401 may comprise a complimentary internal thread into which the brush holder chassis 412 can be screwed into. The respective thread may have a single turn which may extend along the entire annular wall of the housing 401 and the entire annular outer surface of the brush holder chassis 412. Other arrangements are contemplated wherein the thread(s) may not extend all the way around the housing 401 or the brush holder chassis 412. It will be appreciated that the number of turns of the respective thread may differ. The respective thread may comprise less than one turn, for example a quarter of a turn, or half a turn. The respective thread may comprise two or more turns. The two or more turns may be axially offset from each another. The two or more turns may each extend the entire annular extent of the annular inner surface of the housing 401 or the annular outer surface of the brush holder chassis 412.

The housing 401 of the cleaning tool 400 may be formed of a polycarbonate such as MAKROLON 2805®. A support or shaft 414 may be connected to the brush holder chassis 412 and the support or shaft 414 may project away from a brush holder housing 413 which is attached to the brush holder chassis 412. The brush holder housing 413 may be formed from a co-polymer such as Polyacetal (POM) M90-44. The brush holder chassis 412 may be formed from a polycarbonate such as MAKROLON 2805®.

The support or shaft 414 may comprise stainless steel (such as stainless steel type 304) or an alternative material such as a plastics material. The support or shaft 414 may be attached to the brush holder chassis 412 by glue or a hot melt connect. The material comprising the support or shaft 414 may be selected such that the support or shaft 414 can be bent into a number of different orientations as desired.

At a distal end 416 of the support or shaft 414 a plurality of bristles 415 may be disposed. The bristles 415 may be formed from polyetheretherketone (PEEK) such as ZYPEEK 770G®. It has been found that PEEK is particularly suited for clean out operations due to its beneficial material properties. For example, PEEK has a high melting point in the range of 250° C. to 345° C., which may be above the temperature of an aerosol provision device after it has completed a heating operation. The bristles 415 may be conveniently cut to size. According to an arrangement the bristles 415 may tapered in a direction from a first end closest to the brush holder housing 413 connected to the brush holder chassis 412 to the distal end 416. For example, the bristles 415 closest to the brush holder housing 413 of the brush holder chassis 412 may extend a first radial distance and the bristles 415 at the distal end 416 of the support or shaft 414 may extend a second radial desistance, wherein the first radial distance may be greater than the second radial distance, or vice versa.

According to various arrangements the bristles 415 may have a thickness of 0.1-0.3 mm. According to arrangements the bristles may have a thickness of 0.1-0.2 mm or 0.2-0.3 mm.

The bristles 415 may be inserted into the support or shaft 414 and then trimmed to a desired length. The support or shaft 414 may then be inserted into the brush holder chassis 412 and then optionally be bent into any suitable orientation.

The cleaning tool 400 may be used to clean an aerosol provision device such as an aerosol provision device as shown and described above with reference to FIGS. 1-4. In order to use the cleaning tool 400, a user could remove the brush holder chassis 412 from the housing 401 and then insert the distal end 416 through the opening 190 of the aerosol provision device 100 with the end cover 300 removed (see FIG. 2). The user would then be free to insert the cleaning tool into a receptacle 222 of the aerosol provision device 100 (see FIG. 3) when no article is present in the receptacle 222. The user may then move the cleaning tool 400 in different orientations so that the plurality of bristles 415 remove any lose debris collected in the bottom of the receptacle 222.

The brush holder housing 413 connected to the brush holder chassis 412 may comprise a shoulder around its rim for engaging with an outer surface of the opening 190 thereby preventing stress to internal components, when using the cleaning tool 400 to clean the aerosol provision device 100. Other arrangements are contemplated wherein the brush holder housing 413 does not have a defined shoulder.

The bristles 415 of the cleaning tool 400 may be used to scrub the inner walls of the receptacle 222 (see FIG. 3) in order to remove any material that has adhered to the inner surface of the receptacle 222. The bristles 415 may also advantageously be used to clean the heating element or susceptor 220 without damaging the heating element or susceptor 220. If the cleaning tool 400 were not provided, a user might attempt to clean the inside of the receptacle 222 with their fingers or a blunt object which might cause damage to internal components within the aerosol provision device 100. In should also be understood that if a spent article were removed shortly after use, then the inside of the aerosol provision device 100 may be at a relatively high temperature. Accordingly, the use of the cleaning tool 400 prevents a user from burning themselves if they attempted to clean the aerosol provision device 100 without the cleaning tool 400.

According to various arrangements the support or shaft 414 may comprise two twisted wires which may be arranged so as to secure the plurality of bristles 415 in place relative to support or shaft 414. The support or shaft 414 may have any other suitable form. In the arrangement shown in FIG. 5 the support or shaft 414 is straight. However, it will be appreciated that the support or shaft 414 may have any other suitable profile that facilitates cleaning of the heating element or susceptor 220 and/or the inner walls of the receptacle 222 within the aerosol provision device 100.

In the arrangement shown in FIG. 5, the plurality of bristles 415 are shown extending radially away from the support or shaft 414. Whilst a specific form of brush is depicted, i.e. one which comprises bristles 415, it will be appreciated that a brush may be provided which comprises any suitable element which will contact a part of the aerosol provision device during use of the cleaning tool 400. For example, the brushes may comprise a series of blades or pads which perform a cleaning action.

Also shown in FIG. 5 is an optional article remover tool 420 comprising a handle or base portion 422 and a screw 424 projecting from the handle or base portion 422. The handle or base portion 422 may be shaped such that it can be held in or docked to the brush holder chassis 412 of the brush holder 410. In use, the screw end 424 can be screwed into an article which may stuck in the aerosol provision device in order to remove the article. The screw 424 may be formed of stainless steel (304), although other materials are contemplated. According to an arrangement the screw 424 may have an outer diameter of 3.5 mm and a pitch of 7.2 mm. The wire forming the screw 424 may have a diameter of 1 mm. The handle or base portion 422 may comprise a polycarbonate such as MAKROLON 2805®.

FIG. 6 shows in more detail a distal end 440 of the housing 401 of the cleaning tool 400. The housing 401 further comprises an engagement feature 430 for engaging with a cover of an aerosol provision device, such as the outer cover 300 of the aerosol provision device 100 shown and described above for example with reference to FIG. 2. The engagement feature 430 may be arranged to open, remove or displace the outer cover 300.

The engagement feature 430 may protrude from the housing 401 and may comprise a plurality of hooks 432 for engagement with a corresponding recess(es) of a tool slot 312 provided on the outer cover 300 (see FIG. 4) thereby acting to secure the cleaning tool 400 to the outer cover 300 of the aerosol provision device. The tool slot 312 and the engagement feature 430 may be arranged to have complimentary geometries. The engagement feature 430 may be disposed centrally on the distal end 440 of the cleaning tool 400 and may be elongate. According to other arrangements the geometry and location of the tool slot 312 may differ.

In use, a user may insert the engagement feature 430 into the tool slot 312 of the outer cover 300 in order to form a secure connection. The user may then rotate or pull the engagement feature 430 in order to remove or displace the outer cover 300 thereby exposing the opening 190 for subsequent cleaning by the cleaning tool 400. The engagement feature 430 may be configured to aid in inserting and removing (or displacing) an outer cover 300 in order to provide access via an opening 190 in order to facilitate cleaning of an internal portion of the aerosol provision device.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilized and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. An aerosol provision system, comprising:
an aerosol provision device comprising a cover; and
a cleaning tool for cleaning the aerosol provision device, wherein the cleaning tool comprises:
a first part comprising a handle portion having a support depending or extending therefrom and a plurality of bristles or pads depending or extending from a distal end of the support; and
a second part comprising a housing for receiving the first part, wherein the housing further comprises an engagement mechanism for engaging with a cover of an aerosol provision device in order to remove or displace the cover,
wherein the engagement mechanism of the second part of the cleaning tool is arranged to engage the cover in use in order to remove or displace the cover.

2. The aerosol provision system as claimed in claim 1, wherein the support is formed from at least two strands of wire which are twisted together in order to secure the plurality of bristles or pads in position.

3. The aerosol provision system as claimed in claim 1, wherein the plurality of bristles or pads extend radially from the support.

4. The aerosol provision system as claimed in claim 1, wherein the support is straight, bent or curved.

5. The aerosol provision system as claimed in claim 1, wherein the handle portion of the first part comprises an external thread and the housing of the second part comprises a complimentary internal thread for securing the first and second parts together in a storage configuration.

6. The aerosol provision system as claimed in claim 1, wherein the housing of the second part houses at least a portion of the first part in a storage configuration.

7. The aerosol provision system as claimed in claim 1, wherein the engagement mechanism enables a cover of an aerosol provision device to be rotated or displaced.

8. The aerosol provision system as claimed in claim 1, wherein the engagement mechanism comprises a first protrusion for engaging with a first slot or cut-out provided in a cover of an aerosol provision device.

9. The aerosol provision system as claimed in claim 8, wherein the engagement mechanism further comprises a second protrusion having a different shape and/or dimension to the first protrusion, wherein the second protrusion is arranged to engage with a second slot or cut-out provided in the aerosol provision device, wherein the second slot or cut-out has a different shape and/or dimension to the first slot or cut-out.

10. The aerosol provision system as claimed in claim 1, wherein the handle of the first part further comprises a shoulder for resting in an aperture of an aerosol provision device when a cover has been removed or displaced by the engagement mechanism.

11. The aerosol provision system as claimed in claim 1, wherein the plurality of bristles comprise PEEK.

12. The aerosol provision system as claimed in claim 1, wherein the support comprises stainless steel.

13. The aerosol provision system as claimed in claim 1, wherein the cleaning tool further comprises a third part, wherein the third part comprises a handle having a screw member dependent or extending therefrom for removing an aerosol generating article from an aerosol provision device.

14. The aerosol provision system as claimed in claim 13, wherein the screw member comprises stainless steel.

15. The aerosol provision system as claimed in claim 13, wherein the housing of the second part is further configured to receive the third part in a storage configuration.

16. The aerosol provision system as claimed in claim 13, wherein the housing of the second part houses at least a portion of the third part in a storage configuration.

17. A method of cleaning an aerosol provision device comprising:
engaging the engagement mechanism of the system as claimed in claim 1 with the cover of the aerosol provision device in order to remove or displace the cover;
inserting the plurality of bristles or pads of the first part of the cleaning tool into a receptacle of the aerosol provision device; and
translating the handle portion of the first part between first and second positions along a longitudinal axis of the aerosol provision device.

18. A method of cleaning an aerosol provision device as claimed in claim 17, further comprising moving the handle portion of the first part between the first and second positions a plurality of times.

19. A method of cleaning an aerosol provision device as claimed in claim 17, further comprising rotating the handle portion of the first part about the longitudinal axis of the aerosol provision device by at least a partial rotation.

20. (canceled).

21. (canceled).

22. A cleaning tool for cleaning an aerosol provision device comprising:
a first part comprising a handle portion having a support depending or extending therefrom and a plurality of bristles or pads depending or extending from a distal end of the support; and
a second part comprising a housing for receiving the first part, wherein the housing further comprises an engagement mechanism for engaging with a cover of an aerosol provision device in order to remove or displace the cover.
